(19) United States
(12) Patent Application Publication
(10) Pub. No.: US 2016/0223776 A1
(43) Pub. Date: Aug. 4, 2016

(54) LENS MODULE

(71) Applicant: Samsung Electro-Mechanics Co., Ltd., Suwon-si (KR)

(72) Inventor: Kwang Yun CHOI, Suwon-si (KR)

(73) Assignee: Samsung Electro-Mechanics Co., Ltd., Suwon-si (KR)

(21) Appl. No.: 14/959,389

(22) Filed: Dec. 4, 2015

(30) Foreign Application Priority Data
Feb. 2, 2015 (KR) 10-2015-0016011

(51) Int. Cl. G02B 7/00; G02B 7/02

(52) U.S. Cl. CPC G02B 7/008; G02B 7/021

(57) ABSTRACT

A lens module includes: a first lens including a concave part and a first outer horizontal surface extended from an outer side of the concave part; a second lens including a convex part coupled to the concave part and a second outer horizontal surface extended from an outer side of the convex part; and a first ventilation part disposed between the convex part and the concave part such that a space between the first lens and the second lens is connected with an outside environment.

### CROSS-REFERENCE TO RELATED APPLICATION(S)

This application claims the benefit of Korean Patent Application No. 10-2015-0016011 filed on Feb. 2, 2015 in the Korean Intellectual Property Office, the entire disclosure of which is incorporated herein by reference for all purposes.

### BACKGROUND

1. Field

The following description relates to a lens module.

2. Description of Related Art

A lens barrel accommodating lenses is provided in a lens module used for a camera. The lenses are inserted into the lens barrel and are fixed thereto. In a case in which the lenses are closely adhered to each other without gaps, or the lenses and the lens barrel are closely adhered to each other without a gap, the lenses are attached in a state in which air is confined therebetween.

It is undesirable for the air confined between the lenses to contract or expand depending on temperature changes within a surrounding environment, since an attachment position of the lenses may be changed by the contraction or expansion of the air confined between the lenses.

In addition, it is undesirable for the air confined between the lenses to become liquefied due to a condensation phenomenon, since the performance of the camera module may be deteriorated by condensation between the lenses. Therefore, it is required that the air confined between the lenses be circulated externally.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a lens module includes: a first lens including a concave part and a first outer horizontal surface extended from an outer side of the concave part; a second lens including a convex part coupled to the concave part and a second outer horizontal surface extended from an outer side of the convex part; and a first ventilation part disposed between the convex part and the concave part such that a space between the first lens and the second lens is connected with an outside environment.

The first ventilation part may include a gap formed between the convex part and the concave part.

The concave part may include an inclined first conical surface and a first inner horizontal surface extended to an inner side of the first conical surface, and the convex part may include a second conical surface facing the first conical surface and a second inner horizontal surface extended to an inner side of the second conical surface.

The first inner horizontal surface and the second inner horizontal surface may be spaced apart from each other.

A first portion of the second conical surface may be spaced apart from the first conical surface, and a second portion of the second conical surface may be closely adhered to the first conical surface.

The second portion of the second conical surface may include a vertical plane, and the first portion of the second conical surface may include an inclined curved surface.

Some portions of the first outer horizontal surface and the second outer horizontal surface may be closely adhered to each other, and other portions of the first outer horizontal surface and the second outer horizontal surface may be spaced apart from each other.

At least one of the first outer horizontal surface or the second outer horizontal surface may include a second ventilation part communicating with the first ventilation part.

The second ventilation part may be formed by a portion of the first outer horizontal surface having a surface roughness that is greater than a surface roughness of another portion of the first outer horizontal surface, or a portion of the second outer horizontal surface having a surface roughness that is greater than a surface roughness of another portion of the second outer horizontal surface.

The second ventilation part may include a groove formed in at least one of the first outer horizontal surface or the second outer horizontal surface.

The lens module may further include a lens barrel in which the first lens and the second lens are attached to be laminated.

The lens module may further include a third ventilation part in communication with the second ventilation part between a side surface of the second lens and an inner surface of the lens barrel, wherein the side surface of the second lens and the inner surface of the lens barrel are connected to each other.

The third ventilation part may be formed by a portion of the side surface of the second lens having a surface roughness that is greater than a surface roughness of another portion of the side surface of the second lens, or a portion of the inner surface of the lens barrel having a surface roughness that is greater than a surface roughness of the another portion of the inner surface of the lens barrel.

The third ventilation part may include a groove formed in at least one of the side surface of the second lens or the inner surface of the lens barrel.

According to another general aspect, a lens module includes: a lens barrel; a first lens and a second lens attached to be laminated in the lens barrel; and air channels formed between the first lens and the second lens and between the second lens and the lens barrel such that a space between the first lens and the second lens is connected with an outside environment.

The first lens may include a concave part and the second lens may include a convex part coupled to the concave part. A portion of the convex part may not be in contact with the concave part, and another portion of the convex part may be in contact with the concave part. A portion of a side surface of the second lens may not be in contact with an inner surface of the lens barrel, and another portion of the side surface of the second lens may be in contact with the inner surface of the lens barrel.

The air channels may be formed by roughened surfaces of the first lens or roughened surfaces of the second lens.

The air channels may be formed by grooves in the first lens or grooves in the second lens.

Other features and aspects will be apparent from the following detailed description, the drawings, and the claims.

### BRIEF DESCRIPTION OF DRAWINGS

FIG. 1 is a cross-sectional view of a lens module according to an example.

FIG. 2 is an enlarged view of part A of FIG. 1.

FIG. 3 is a perspective view of a second lens provided in the lens module according to an example.

FIG. 4 is a view illustrating a modified example of a second ventilation part and a third ventilation part of the lens module.

FIG. 5 is a perspective view of a second lens according to the modified example of FIG. 4.

FIGS. 6 and 7 are views illustrating second lenses including a modified example of a second conical surface of a convex part of the lenses.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

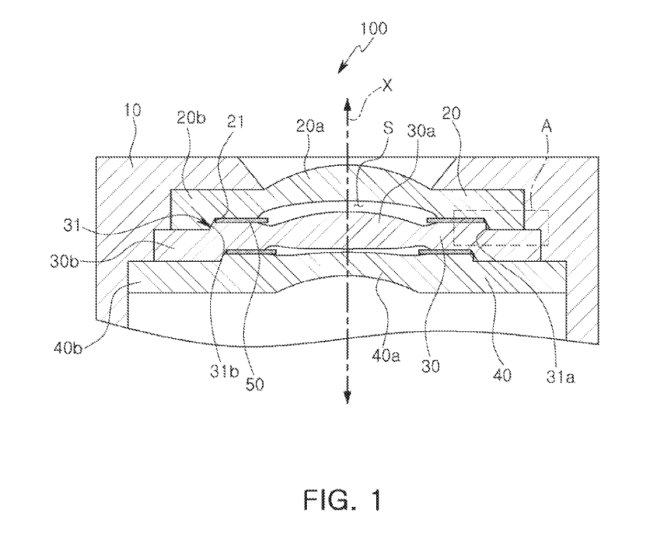

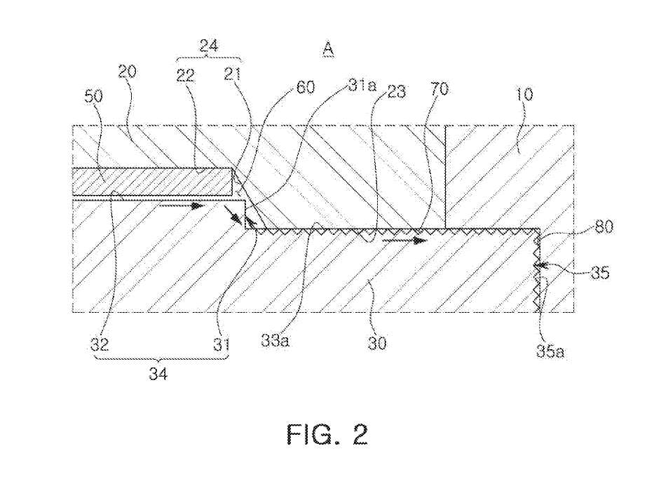

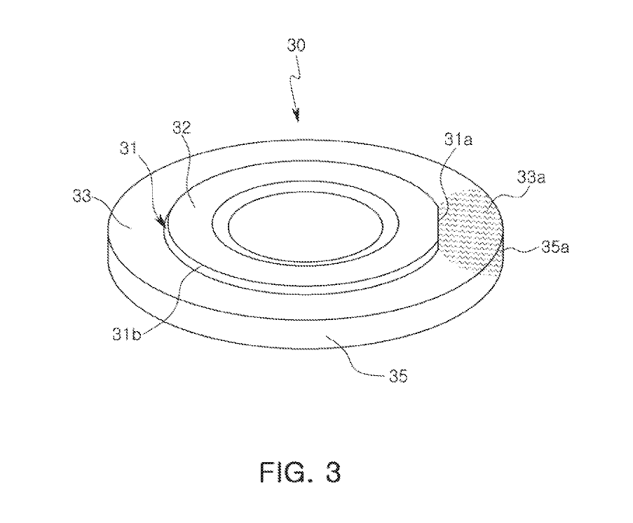

FIG. 1 is a cross-sectional view of a lens module 100 according to an example. FIG. 2 is an enlarged view of part A of FIG. 1. FIG. 3 is a perspective view of a second lens 30 provided in the lens module 100 according to an example.

Referring to FIGS. 1 through 3, the lens module 100 includes a lens barrel 10 and lenses 20, 30, and 40 attached to be laminated in the lens barrel 10.

The lens barrel 10 may have a hollow cylindrical shape so that the lenses 20, 30, and 40 photographing a subject are accommodated therein, and the lenses 20, 30, and 40 are attached in the lens barrel 10 along an optical axis X.

A required number of the lenses 20, 30, and 40 may be laminated depending on a design of the lens module 100, and may have optical characteristics such as the same refractive index, different refractive indices, or the like.

The lenses 20, 30, and 40 each include an optical part (20a, 30a, and 40a, respectively) configured to refract incident light reflected from the subject, and a rib (20b, 30b, and 40b, respectively) extended from the optical part to an outer side of the respective lens.

Spacers 50 are disposed between the lenses 20, 30, and 40 to maintain gaps between the lenses. The lenses 20, 30, and 40 are disposed to be spaced apart from each other by a predetermined gap by the spacers 50. The spacers 50 may be provided in a film shape, or may be provided in a shape having a predetermined thickness.

The spacers 50 may be coated with a light blocking material or may be attached with a light blocking film while preventing unnecessary incident light from being transmitted through the spacers 50. In addition, the spacers 50 may be formed of an opaque material. For example, the spacers 50 may be formed of a nonferrous metal such as copper, aluminum, or the like. In this case, there may be advantages in that the spacers 50 may easily be formed and manufacturing costs of the spacers 50 may be reduced.

Referring to FIG. 1, although the example therein illustrates the first lens 20 disposed to be closest to an object side, the second lens 30 laminated on the first lens 20, and the third lens 40 laminated on the second lens 30, the scope of the present disclosure is not limited to this number of lenses. For example, the lens module 100 may include more or less than 3 lenses, depending on resolution to be implemented.

Hereinafter, a description will be provided in relation to the first lens 20 and the second lens 30 for convenience of explanation. In the following description, a first surface of each lens 20 and 30 refers to a surface thereof closest to an object side (or an object-side surface) and a second surface of each lens 20 and 30 refers to a surface thereof closest to an image side (or an image-side surface).

A second surface of the first lens 20 includes a concave part 24. For example, the second surface of the first lens 20 includes an inclined first conical surface 21, and a first inner horizontal surface 22 and a first outer horizontal surface 23 formed at opposite sides of the first conical surface 21. The first outer horizontal surface 23 is formed in an outer direction (a direction moving away from an optical axis X) from the first conical surface 21. Conversely, the first inner horizontal surface 22 is formed in an inner direction (a direction moving toward the optical axis X) from the first conical surface 21.

Therefore, the second surface of the first lens 20 includes the concave part 24 formed to be concave by the inclined first conical surface 21 and the first inner horizontal surface 22 extended in the inner direction from the first conical surface 21. Since the first conical surface 21 has an inclined curve, the concave part 24 has a conical shape.

A first surface of the second lens 30 facing the second surface of the first lens 20 includes a convex part 34 protruding to the concave part 24. For example, the first surface of the second lens 30 includes an inclined second conical surface 31 formed at a position facing the first conical surface 21, and a second inner horizontal surface 32 and a second outer horizontal surface 33 formed at opposite sides of the second conical surface 31. The second outer horizontal surface 33 is formed in an outer direction (a direction moving away from the optical axis X) from the second conical surface 31. Conversely, the second inner horizontal surface 32 may be formed in an inner direction (a direction moving toward the optical axis X) from the second conical surface 31.

Therefore, the first surface of the second lens 30 includes the convex part 34 formed to protrude to the concave part 24 by the inclined second conical surface 31, and the second inner horizontal surface 32 extended in the inner direction from the second conical surface 31. Since the second conical surface 31 has an inclined curve, the convex part 34 has a conical shape.

The first inner horizontal surface 22 of the first lens 20 and the second inner horizontal surface 32 of the second lens 30 are spaced apart from each other, and the spacer 50 is disposed between the first inner horizontal surface 22 and the second inner horizontal surface 32. In this case, the spacer 50 is closely adhered to the first inner horizontal surface 22 and is spaced apart from the second inner horizontal surface 32. Therefore, a predetermined gap is formed between the second inner horizontal surface 32 and the spacer 50.

The first lens 20 and the second lens 30 are attached to be laminated in the lens barrel 10. For example, the convex part 34 is inserted in and coupled to the concave part 24, and thus the first lens 20 and the second lens 30 are coupled to each other. As shown in FIG. 1, when the first lens 20 and the second lens 30 are coupled to each other, a space S is formed between an optical part of the first lens 20 and an optical part of the second lens 30.

In a case in which the entire surfaces of the first lens 20 and the second lens 30 are coupled to each other such that they are closely adhered, it is difficult to externally discharge air from the space S. Therefore, when the first lens 20 and the second lens 30 are coupled to each other, the air in the space S expands, and thus a coupled position of the second lens 30 may be misaligned. In addition, since it is difficult to externally circulate the air in the space S after attachment of the lenses 20 and 30 has been completed, water vapor condensation may occur in the space S due to changes in temperature and humidity of a surrounding environment. Thus, the lens module according 100 includes a first ventilation part 60 between the convex part 34 and the concave part 24, and thus the air in the space S is connected with the outside environment through the first ventilation part 60.

The first ventilation part 60 may be a gap formed between the first conical surface 21 of the concave part 24 and the second conical surface 31 of the convex part 34. The gap serves as an air channel allowing the air in the space S to be connected with the outside.

In the lens module 100, a portion 31a of the second conical surface 31 is spaced apart from the first conical surface 21, and another portion 31b (FIGS. 1 and 3) of the second conical surface 31 is closely adhered to the first conical surface 21. Thus, the air channel is formed in the portion 31a at which the first conical surface 21 and the second conical surface 31 are spaced apart from each other, and the air channel is used as the first ventilation part 60.

Referring to FIG. 2, the portion 31a of the second conical surface 31 may have a cut shape. Therefore, as illustrated in FIGS. 1 and 3, the portion 31a of the second conical surface 31 may be a plane parallel to the optical axis, and the other portion 31b of the second conical surface 31 may be an inclined curved surface. Thus, as illustrated in FIG. 3, when being viewed from an optical axis direction, the convex part 34 may be formed to have a D′ shape.

Thus, in a case in which the convex part 34 is coupled to the concave part 24, since the cut portion 31 a of the second conical surface 31 is spaced apart from the first conical surface 21, the first ventilation part 60 may be formed between the convex part 34 and the concave part 24.

Meanwhile, the first lens 20 includes the first outer horizontal surface 23 extended to an outer side of the concave part 24, and the second lens 30 includes the second outer horizontal surface 33 closely adhered to the first outer horizontal surface 23. Some portions of the first outer horizontal surface 23 and the second outer horizontal surface 33 may be closely adhered to each other, while other portions of the first outer horizontal surface 23 and the second outer horizontal surface 33 may be spaced apart from each other. Here, at least one of the first outer horizontal surface 23 or the second outer horizontal surface 33 includes a second ventilation part 70 which communicates with the first ventilation part 60.

The second ventilation part 70 is formed by forming a surface roughness of a portion of at least one of the first outer horizontal surface 23 or the second outer horizontal surface 33 to be rougher than that of other portions of the first outer horizontal surface 23 or the second outer horizontal surface 33. For example, the surface roughness may be changed by performing caustic etching on a surface of a portion of at least one of the first outer horizontal surface 23 or the second outer horizontal surface 33.

Referring to FIGS. 2 and 3, the surface roughness of a portion 33a of the second outer horizontal surface 33 is formed to be rougher than that of the other portions of the second outer horizontal surface 33. Thus, an air channel is formed between the first outer horizontal surface 23 and the second outer horizontal surface 33, and the air channel serves as the second ventilation part 70.

In the case in which the first lens 20 and the second lens 30 are attached to be laminated in the lens barrel 10, side surfaces of the first lens 20 and the second lens 30 are in contact with an inner surface of the lens barrel 10.

A third ventilation part 80 communicating with the second ventilation part 70 is provided between a side surface 35 of the second lens 30 and the inner surface of the lens barrel 10. The third ventilation part 80 may be formed by changing surface roughness, similar to the second ventilation part 70. For example, the third ventilation part 80 may be formed by forming a surface roughness of a portion of at least one of the side surface 35 of the second lens 30 or the inner surface of the lens barrel 10 to be rougher than that of the other portions of the second lens 30 or the lens barrel 10. Referring to FIGS. 2 and 3, the roughness of a portion 35a of the side surface 35 is formed to be rougher than that of the other portions of the side surface 35.

Thus, the first ventilation part 60, the second ventilation part 70 and the third ventilation part 80, which communicate with each other, are provided between the first lens 20 and the second lens 30. As a result, the space S between the first lens 20 and the second lens 30 may be in communication with the outside environment.

That is, the space S between the first lens 20 and the second lens 30 is connected with the outside environment through the gap between the second inner horizontal surface 32 and the spacer 50, the first ventilation part 60 formed between the first conical surface 21 and the second conical surface 31, the second ventilation part 70 formed between the first outer horizontal surface 23 and the second outer horizontal surface 33, and the third ventilation part 80 formed between the side surface 35 of the second lens 30 and the inner surface of the lens barrel 10.

Thus, when the first lens 20 and the second lens 30 are coupled to each other, since expansion of the air between the first lens 20 and the second lens 30 may be prevented, misalignment of the attached position of the second lens 30 may be prevented.

In addition, even after the attachment of the first lens 20 and the second lens 30 is finished, since the space S between the first lens 20 and the second lens 30 is connected with the outside environment, the formation of water vapor condensation between the first lens 20 and the second lens 30 due to changes in temperature and humidity of the surrounding environment may be prevented.

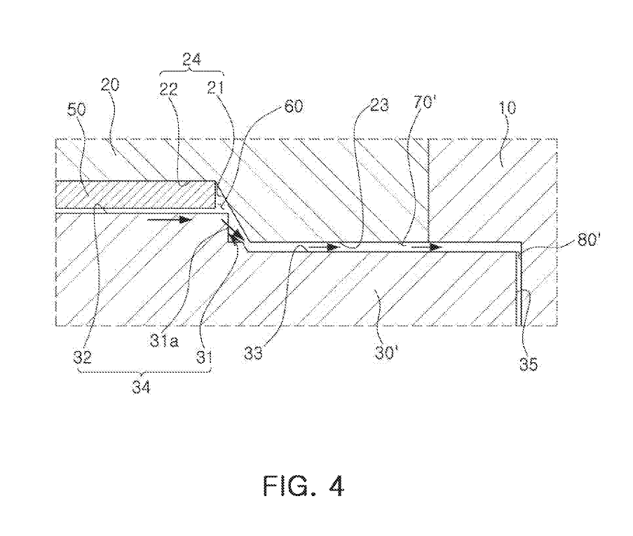

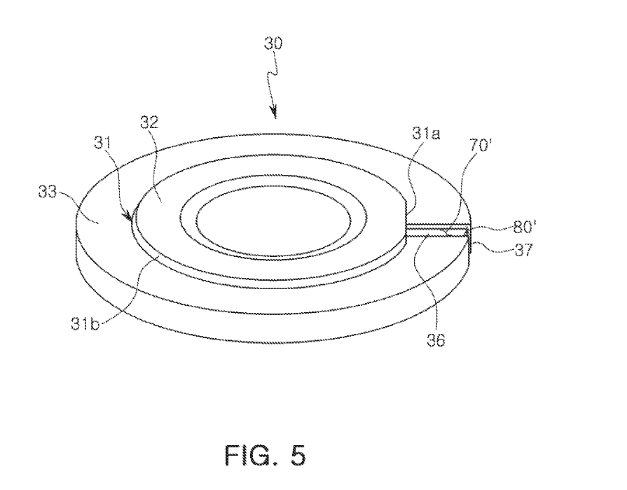

FIG. 4 is a view illustrating a modified example of a second lens 30′ that, in conjunction with the first lens 20, forms a second ventilation part 70′ and a third ventilation part 80′. FIG. 5 is a perspective view of the second lens 30′ according to the modified example of FIG. 4.

Referring to FIGS. 4 and 5, a groove may be formed in at least one of the first outer horizontal surface 23 and the second outer horizontal surface 33. More specifically, as shown in FIG. 5, a groove 36 is formed in the second outer horizontal surface 33 of the second lens 30′. An air channel is formed by the groove 36, and the air channel serves as the second ventilation part 70′.

In addition, a groove may be formed in at least one of the side surface 35 of the second lens 30′ and the inner surface of the lens barrel 10. More specifically, as shown in FIG. 5, a groove 37 is formed in the side surface 35 of the second lens 30′. Thus, an air channel is also formed between the side surface 35 of the second lens 30′ and the inner surface of the lens barrel 10, and this air channel serves as the third ventilation part 80′.

Thus, the example of FIGS. 4 and 5 lacks the roughened portions 33a and 35a of the second outer horizontal surface 33 and the side surface 35, respectively, and instead includes the grooves 36 and 37 to form the second ventilation part 70′ and the third ventilation part 80′.

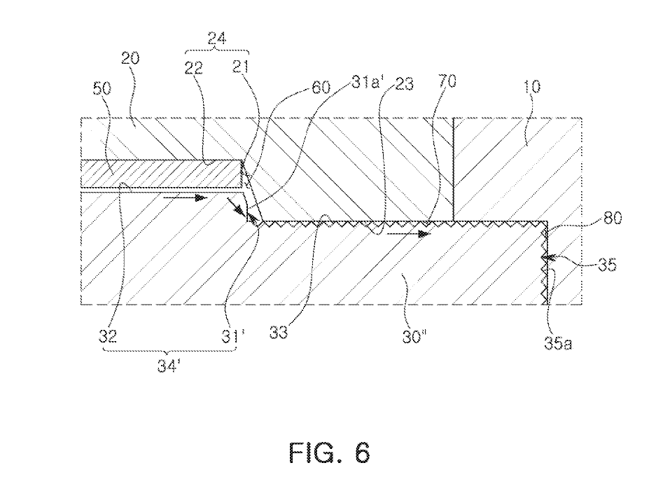

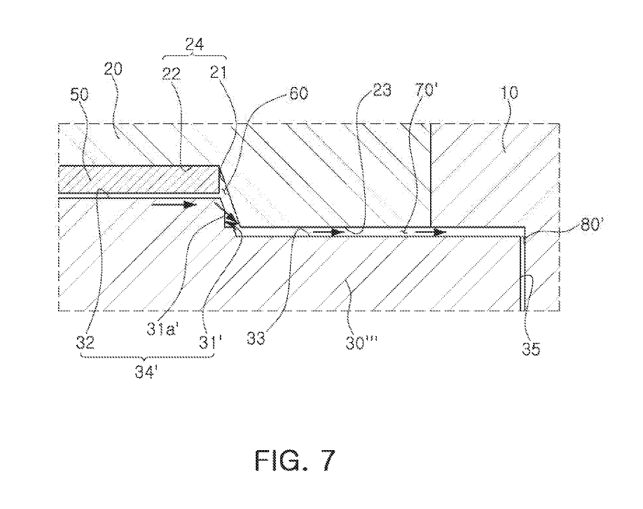

FIGS. 6 and 7 are views illustrating a modified example of a second conical surface of a convex part 34′ of second lenses 30″ and 30″', respectively. The lens 30″ shown in FIG. 6 is similar to the lens 30 of FIGS. 1-3, with the exception of the convex part 34′, while the lens 30″ shown in FIG. 7 is similar to the lens 30′ of FIGS. 4 and 5, with the exception of the of the convex part 34′.

Referring to FIGS. 6 and 7, a portion 31a′ of the second conical surface 31′ of the convex part 34′ of the second lenses 30″ and 30″′ may be cut such that one part of the cut portion 31a′ is a vertical plane, and another part of cut the portion 31a′ is an inclined curved surface.

More specifically, the cut portion 31a′ includes an inclined surface, having the same gradient as that of the inclined curved surface (portion 31b, as shown in FIGS. 3 and 5) of the second conical surface 31′, provided between the second inner horizontal surface 32 and the vertical plane of the portion 31a′.

When the convex part 34′ of the second lens 30″/30″′ is coupled to the concave part 24 of the first lens 20, the inclined surface of the cut portion 31a′ may prevent an edge portion of the convex part 34′ of the second lens 30 from being damaged by contact shock.

As set forth above, according to the examples disclosed herein, the lens module allows the space between the lenses to be connected with the outside environment. As a result, an alteration of the attachment position of the lenses or the formation of water vapor condensation due to air between the lenses during an attachment process of the lenses or after the attachment of the lenses may be prevented.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a first lens comprising a concave part and a first outer horizontal surface extended from an outer side of the concave part;
a second lens comprising a convex part coupled to the concave part and a second outer horizontal surface extended from an outer side of the convex part; and
a first ventilation part disposed between the convex part and the concave part such that a space between the first lens and the second lens is connected with an outside environment.

2. The lens module of claim 1, wherein the first ventilation part comprises a gap formed between the convex part and the concave part.

3. The lens module of claim 1, wherein:
the concave part comprises an inclined first conical surface and a first inner horizontal surface extended to an inner side of the first conical surface; and
the convex part comprises a second conical surface facing the first conical surface and a second inner horizontal surface extended to an inner side of the second conical surface.

4. The lens module of claim 3, wherein the first inner horizontal surface and the second inner horizontal surface are spaced apart from each other.

5. The lens module of claim 3, wherein a first portion of the second conical surface is spaced apart from the first conical surface, and a second portion of the second conical surface is closely adhered to the first conical surface.

6. The lens module of claim 5, wherein the second portion of the second conical surface comprises a vertical plane, and the first portion of the second conical surface comprises an inclined curved surface.

7. The lens module of claim 1, wherein some portions of the first outer horizontal surface and the second outer horizontal surface are closely adhered to each other, and other portions of the first outer horizontal surface and the second outer horizontal surface are spaced apart from each other.

8. The lens module of claim 1, wherein at least one of the first outer horizontal surface or the second outer horizontal surface comprises a second ventilation part communicating with the first ventilation part.

9. The lens module of claim 8, wherein the second ventilation part is formed by a portion of the first outer horizontal surface having a surface roughness that is greater than a surface roughness of another portion of the first outer horizontal surface, or a portion of the second outer horizontal surface having a surface roughness that is greater than a surface roughness of another portion of the second outer horizontal surface.

10. The lens module of claim 8, wherein the second ventilation part comprises a groove formed in at least one of the first outer horizontal surface or the second outer horizontal surface.

11. The lens module of claim 8, further comprising a lens barrel in which the first lens and the second lens are attached to be laminated.

12. The lens module of claim 11, further comprising a third ventilation part in communication with the second ventilation part between a side surface of the second lens and an inner surface of the lens barrel, wherein the side surface of the second lens and the inner surface of the lens barrel are connected to each other.

13. The lens module of claim 12, wherein the third ventilation part is formed by a portion of the side surface of the second lens having a surface roughness that is greater than a surface roughness of another portion of the side surface of the second lens, or a portion of the inner surface of the lens barrel having a surface roughness that is greater than a surface roughness of the another portion of the inner surface of the lens barrel.

14. The lens module of claim 12, wherein the third ventilation part comprises a groove formed in at least one of the side surface of the second lens or the inner surface of the lens barrel.

15. A lens module comprising:
a lens barrel;
a first lens and a second lens attached to be laminated in the lens barrel; and
air channels formed between the first lens and the second lens and between the second lens and the lens barrel such that a space between the first lens and the second lens is connected with an outside environment.

16. The lens module of claim 15, wherein:
the first lens comprises a concave part;
the second lens comprises a convex part coupled to the concave part;
a portion of the convex part is not in contact with the concave part;
another portion of the convex part is in contact with the concave part;
a portion of a side surface of the second lens is not in contact with an inner surface of the lens barrel; and
another portion of the side surface of the second lens is in contact with the inner surface of the lens barrel.

17. The lens module of claim 15, wherein the air channels are formed by roughened surfaces of the first lens or roughened surfaces of the second lens.

18. The lens module of claim 15, wherein the air channels are formed by grooves in the first lens or grooves in the second lens.
